(19) United States
(12) Patent Application Publication
(10) Pub. No.: US 2026/0127132 A1
(43) Pub. Date: May 7, 2026

(54) SPI INTERFACE SYSTEM, SPI DATA WRITING METHOD, AND SPI DATA READING METHOD

(71) Applicant: NOREL SYSTEMS LIMITED, Tianjin (CN)

(72) Inventors: Yuanlong WANG, Tianjin (CN); Hui WANG, Tianjin (CN)

(21) Appl. No.: 19/434,199

(22) Filed: Dec. 29, 2025

Related U.S. Application Data
(63) Continuation of application No. PCT/CN2024/118946, filed on Sep. 14, 2024.

(30) Foreign Application Priority Data
Nov. 17, 2023 (CN) 202311543382.8

(51) Int. Cl. G06F 13/42; G06F 13/40

(52) U.S. Cl. CPC G06F 13/4282; G06F 13/4027

(57) ABSTRACT

The present disclosure provides an SPI interface system, comprising an SPI interface module and at least one functional module; the SPI interface module is connected to an SPI master controller via an SPI_CK signal line, an SPI_MOSI signal line, and an SPI_MISO signal line; the functional module is connected to the SPI interface module. The present disclosure is suitable for application scenarios with long transmission links and is also compatible with local applications with short transmission links, providing an ideal solution for SPI transmission.

### CROSS-REFERENCE TO RELATED APPLICATION

This application is a continuation application of International Patent Application No. PCT/CN 2024/118946, filed on Sep. 14, 2024, which itself claims priority to and benefit of Chinese Patent Application No. 202311543382.8 filed on Nov. 17, 2023 in the State Intellectual Property Office of P. R. China. The disclosure of each of the above applications is incorporated herein by reference in its entirety.

### TECHNICAL FIELD

The present disclosure relates to the field of communication technologies, particularly the encoding, decoding, and transmission of physical layer data, and particularly to an SPI interface system, an SPI data writing method, and an SPI data reading method.

### BACKGROUND

SPI (Serial Peripheral Interface) is a high-speed, full-duplex, synchronous communication bus that uses only four pins on the chip, saving pin resources and simultaneously conserving space on the PCB layout for convenience. SPI typically consists of four signal lines: the SPI_CSN signal line, SPI_CK signal line, SPI_MOSI signal line, and SPI_MISO signal line. The SPI master controller connects to the SPI interface module via these four signal lines, with the master controller serving as the SPI master device and the interface module as the SPI slave device. The master controller drives the SPI_CSN, SPI_CK, and SPI_MOSI signal lines, while the interface module receives these signals. Conversely, the interface module drives the SPI_MISO signal line, which the master controller receives. The interface module samples the data driven by the master controller on the SPI_MOSI signal line at the rising or falling edge of the SPI_CK signal line, while the master controller samples the data driven by the interface module on the SPI_MISO signal line at the rising or falling edge of the SPI_CK signal line. In the SPI protocol, the master controller drives the SPI_CK signal line and generates clock edges on it. Both the master controller and the interface module sample data on the SPI_MISO and SPI_MOSI signal lines at these clock edges, enabling bidirectional data transfer between them. The SPI_CSN signal line serves as the select signal; data transmission occurs only when SPI_CSN is low. A single master controller can connect to multiple interface modules (i.e., one master device to multiple slave devices), sharing the SPI_CK, SPI_MOSI, and SPI_MISO signal lines among them. However, each interface module has its own dedicated SPI_CSN signal line input. When an interface module's SPI_CSN is high, it does not drive the SPI_MISO signal line (its driver output enters a Hi-Z state). An interface module drives SPI_MISO only when its SPI_CSN is low. When a master controller connects to multiple interface modules, only one module's SPI_CSN is low at any given time, preventing conflicts from multiple modules driving the SPI_MISO signal line simultaneously.

When an SPI master controller is connected to only one SPI interface module, this SPI interface module can drive the SPI_MISO signal line at any time without causing conflicts. In this case, there may be no SPI_CSN signal line between the SPI master controller and the SPI interface module. That is, when an SPI master controller is connected to only one SPI interface module, the SPI master controller and the SPI interface module can be connected solely through the SPI_CK signal line, SPI_MOSI signal line, and SPI_MISO signal line.

For long-distance data transmission, the process is generally based on a mode of sending a command packet and then receiving a feedback packet. The feedback packet includes status information about the execution of the command. For a read command, the feedback packet may also include read data. In the existing SPI protocol, bidirectional data transmission between the SPI master controller and the SPI interface module is achieved by sampling data on the SPI_MISO and SPI_MOSI signal lines at the rising or falling clock edges of the SPI_CK signal line. However, this data transmission can be considered a form of data stream transmission and is not suitable for long-distance data transmission. Currently, there is a lack of a solution for long-distance data transmission via SPI interface signals based on the existing SPI protocol.

### SUMMARY

To address the issue in the prior art where the SPI protocol cannot support long-distance transmission, an object of the present disclosure is to provide an SPI interface system. The SPI interface system includes an SPI interface module and at least one functional module.

The SPI interface module is connected to the SPI master controller via the SPI_CK signal line, SPI_MOSI signal line, and SPI_MISO signal line, and the functional module is connected to the SPI interface module.

Another object of the present disclosure is to provide an SPI data writing method, which uses an SPI interface system for data writing and comprises:
the SPI master controller generating a clock edge on the SPI_CK signal line and sending a write command packet to the SPI interface module via the SPI_MOSI signal line, wherein the write command packet starts with a first identifier;
upon receiving the write command packet from the SPI_MOSI signal line, the SPI interface module sending the write command packet to the functional module;
the functional module receiving the write command packet and executing a write command, and after completing the write command, the functional module returning a write status packet to the SPI interface module;
the SPI master controller generating a clock edge on the SPI_CK signal line and reading a write feedback packet via the SPI_MISO signal line; and
upon receiving the write status packet, the SPI interface module sending the write feedback packet via the SPI_MISO signal line, wherein the write feedback packet starts with a second identifier and contains status information comprised in the write status packet.

In a preferred embodiment, if the data received by the SPI interface module from the SPI_MOSI signal line reaches a length of the write command packet, the SPI interface module has received the write command packet.

In a preferred embodiment, the write command packet further comprises a write command packet checksum; and
if the data received by the SPI interface module from the SPI_MOSI signal line reaches the length of the write command packet and the write command packet checksum is verified correctly, the SPI interface module has received the write command packet.

In a preferred embodiment, the SPI master controller generates a clock edge on the SPI_CK signal line and reads the write feedback packet via the SPI_MISO signal line; and
if the SPI interface module does not receive the write status packet, the SPI interface module sends data that cannot be recognized as the write feedback packet to the SPI master controller via the SPI_MISO signal line.

In a preferred embodiment, wherein the SPI interface module comprises a timeout timer;
when the SPI interface module does not receive the write status packet before timeout, if the SPI master controller generates a clock edge on the SPI_CK signal line after timeout, the write feedback packet is read via the SPI_MISO signal line; and
then the SPI interface module sends the write feedback packet to the SPI master controller via the SPI_MISO signal line.

In a preferred embodiment, the SPI master controller generates a clock edge on the SPI_CK signal line and sends the write command packet to the SPI interface module via the SPI_MOSI signal line; and
then the SPI master controller generates a clock edge on the SPI_CK signal line and reads the write feedback packet via the SPI_MISO signal line; and after the SPI interface module sends the write feedback packet via the SPI_MISO signal line, the SPI interface module can continue to receive subsequent command packets, wherein the subsequent command packets comprise write command packets and read command packets.

In a preferred embodiment, the write feedback packet is divided into a write success feedback packet and a write failure feedback packet;
the SPI master controller generates a clock edge on the SPI_CK signal line and reads the write feedback packet via the SPI_MISO signal line;
if the SPI interface module receives the write status packet and the status information contained in the write status packet indicates success, the SPI interface module sends the write success feedback packet via the SPI_MISO signal line, with the write success feedback packet starting with a third identifier; and
if the SPI interface module receives the write status packet and the status information contained in the write status packet indicates failure, the SPI interface module sends the write failure feedback packet via the SPI_MISO signal line, with the write failure feedback packet starting with a fourth identifier.

In a preferred embodiment, the SPI interface module comprises a timeout timer; and
when the SPI interface module does not receive the write status packet before timeout, if the SPI master controller generates a clock edge on the SPI_CK signal line after timeout and reads the write feedback packet via the SPI_MISO signal line, the SPI interface module sends the write failure feedback packet to the SPI master controller via the SPI_MISO signal line.

Yet another object of the present disclosure is to provide an SPI data reading method, which uses an SPI interface system for data reading, and comprises:
the SPI master controller generating a clock edge on the SPI_CK signal line and sending a read command packet to the SPI interface module via the SPI_MOSI signal line, wherein the read command packet starts with a fifth identifier;
after the SPI interface module receives the read command packet from the SPI_MOSI signal line, sending the read command packet to the functional module;
the functional module receiving the read command packet and executing a read command, and when the functional module completes the read command, returning a read data packet to the SPI interface module;
the SPI master controller generating a clock edge on the SPI_CK signal line and reading a read feedback packet via the SPI_MISO signal line; and
upon receiving the read data packet, the SPI interface module sending the read feedback packet via the SPI_MISO signal line, wherein the read feedback packet starts with a sixth identifier and comprises the read data contained in the read data packet.

In a preferred embodiment, if the data received by the SPI interface module from the SPI_MOSI signal line reaches a length of the read command packet, the SPI interface module has received the read command packet.

In a preferred embodiment, the read command packet further comprises a read command packet checksum; and
if the data received by the SPI interface module from the SPI_MOSI signal line reaches the length of the read command packet and the read command packet checksum is verified as correct, the SPI interface module has received the read command packet.

In a preferred embodiment, the SPI master controller generates a clock edge on the SPI_CK signal line and reads the read feedback packet via the SPI_MISO signal line; and
if the SPI interface module does not receive the read data packet, the SPI interface module sends data that cannot be recognized as the read feedback packet to the SPI master controller via the SPI_MISO signal line.

In a preferred embodiment, the SPI interface module comprises a timeout timer; and
if the SPI interface module does not receive the read data packet before timeout, and after timeout, the SPI master controller generates a clock edge on the SPI_CK signal line to read the read feedback packet via the SPI_MISO signal line; and
then the SPI interface module sends the read feedback packet to the SPI master controller via the SPI_MISO signal line.

In a preferred embodiment, the SPI master controller generates a clock edge on the SPI_CK signal line and sends the read command packet to the SPI interface module via the SPI_MOSI signal line; and
then, the SPI master controller generates a clock edge on the SPI_CK signal line and reads the read feedback packet via the SPI_MISO signal line; and after sending the read feedback packet via the SPI_MISO signal line, the SPI interface module can continue to receive subsequent command packets, wherein the subsequent command packets comprise read command packets and write command packets.

In a preferred embodiment, the read feedback packet is divided into a read success feedback packet and a read failure feedback packet;
the SPI master controller generates a clock edge on the SPI_CK signal line and reads the read feedback packet via the SPI_MISO signal line;
if the SPI interface module receives the read data packet and the status information contained in the read data packet indicates success, the SPI interface module sends the read success feedback packet via the SPI_MISO signal line, wherein the read success feedback packet starts with a seventh identifier; and
if the SPI interface module receives the read data packet and the status information contained in the read data packet indicates failure, the SPI interface module sends the read failure feedback packet via the SPI_MISO signal line, wherein the read failure feedback packet starts with an eighth identifier.

In a preferred embodiment, the SPI interface module comprises a timeout timer; and
if the SPI interface module does not receive the read data packet before timeout, and after timeout the SPI master controller generates a clock edge on the SPI_CK signal line to read the read feedback packet via the SPI_MISO signal line, the SPI interface module sends the read failure feedback packet to the SPI master controller via the SPI_MISO signal line.

provided by the present disclosure are suitable for application scenarios with long transmission links and are also compatible with local applications with short transmission links, offering an ideal solution for SPI transmission.

### BRIEF DESCRIPTION OF DRAWINGS

To more clearly illustrate the specific embodiments of the present disclosure or the technical solutions in the prior art, the drawings required for describing the specific embodiments or the prior art will be briefly introduced below. Obviously, the drawings in the following description are some embodiments of the present disclosure. For those of ordinary skill in the art, other drawings can be obtained from these drawings without creative effort.

FIG. 1 schematically shows a structural block diagram of an SPI interface system according to the present disclosure.

FIG. 2 is a schematic diagram of the data structure of a write command packet according to the present disclosure.

FIG. 3 is a timing diagram of an SPI data writing method in one embodiment of the present disclosure.

FIG. 4 is a timing diagram of an SPI data writing method in an embodiment with an SPI_CSN signal line according to the present disclosure.

FIG. 5 is a timing diagram of an SPI data writing method in another embodiment with an SPI_CSN signal line according to the present disclosure.

FIG. 6 is a timing diagram of an SPI data writing method in a second embodiment of the present disclosure.

FIG. 7 is a timing diagram of an SPI data writing method in a third embodiment of the present disclosure.

FIG. 8 is a timing diagram of an SPI data writing method in a fourth embodiment of the present disclosure.

FIG. 9 is a timing diagram of an SPI data writing method in the fifth embodiment of the present disclosure.

FIG. 10 is a timing diagram of an SPI data writing method in the sixth embodiment of the present disclosure.

FIG. 11 is a timing diagram of an SPI data writing method in the seventh embodiment of the present disclosure.

FIG. 12 is a schematic diagram of the read command packet data structure in the present disclosure.

FIG. 13 is a timing diagram of an SPI data reading method in the eighth embodiment of the present disclosure.

FIG. 14 is a timing diagram of an SPI data reading method in the ninth embodiment of the present disclosure.

FIG. 15 is a timing diagram of an SPI data reading method in the tenth embodiment of the present disclosure.

FIG. 16 is a timing diagram of an SPI data reading method in the eleventh embodiment of the present disclosure.

FIG. 17 is a timing diagram of an SPI data reading method in the twelfth embodiment of the present disclosure.

FIG. 18 is a timing diagram of an SPI data reading method in the thirteenth embodiment of the present disclosure.

The meanings of the reference signs are as follows:

100: SPI master controller 100; 200: SPI interface module 200; SPI: Functional module 300; SPI_CK: SPI_CK signal line; SPI_MOSI: SPI_MOSI signal line; SPI_MISO: SPI_MISO signal line; SPI_CSN: SPI_CSN signal line.

### DESCRIPTION OF EMBODIMENTS

To make the above and other features and advantages of the present disclosure clearer, the present disclosure is further described below with reference to the accompanying drawings. It should be understood that the specific embodiments provided herein are for the purpose of explaining to those skilled in the art and are exemplary only, not restrictive.

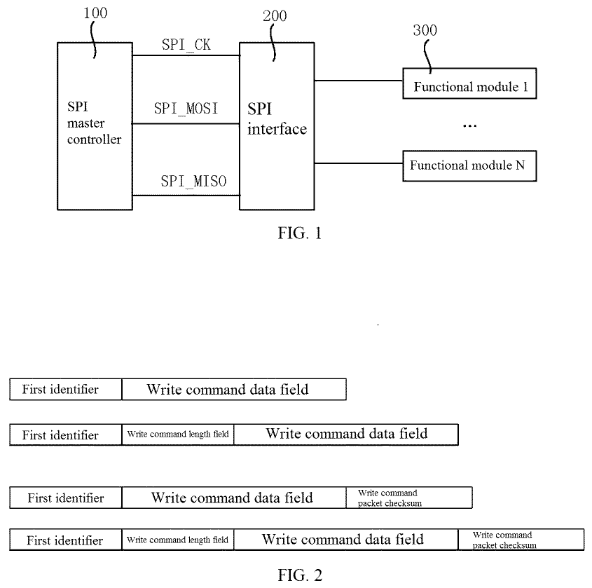

As shown in FIG. 1, according to an embodiment of the present disclosure, an SPI interface system is provided, which includes an SPI master controller 100, an SPI interface module 200, and at least one functional module 300.

The SPI interface module 200 is connected to the SPI master controller 100 via the SPI_CK signal line, SPI_MOSI signal line, and SPI_MISO signal line. The functional module 300 is connected to the SPI interface module 200.

The SPI interface module 200 can connect to multiple functional modules 300, such as functional module 1, . . . , functional module N. In this embodiment, the case where the SPI interface module 200 is connected to one functional module 300 is described as an example.

The SPI master controller 100 serves as the SPI master device, and the SPI interface module 200 serves as the SPI slave device. The SPI master controller 100 drives the SPI_CK signal line and the SPI_MOSI signal line, while the SPI interface module 200 receives the SPI_CK signal line and the SPI_MOSI signal line. The SPI interface module 200 drives the SPI_MISO signal line, and the SPI master controller 100 receives the SPI_MISO signal line.

The present disclosure does not limit the connection method between the SPI interface module 200 and the functional module 300. The SPI interface module 200 can connect to one or more functional modules 300 via one or more transmission lines. Additionally, the present disclosure does not restrict the locations of the SPI interface module 200 and the functional module 300. They may reside within the same integrated circuit chip, on different integrated circuit chips on a single PCB, or even in separate system devices.

### SPI Data Write Method

The SPI master controller 100 generates clock edges on the SPI_CK signal line and sends a write command packet to the SPI interface module 200 via the SPI_MOSI signal line, with the write command packet starting with a first identifier.

Upon receiving the write command packet from the SPI_MOSI signal line, the SPI interface module 200 forwards the write command packet to the functional module 300.

The functional module 300 receives the write command packet and executes the write command. Upon completing the write command, the functional module 300 returns a write status packet to the SPI interface module 200.

The SPI master controller 100 generates clock edges on the SPI_CK signal line and reads a write feedback packet via the SPI_MISO signal line.

When the SPI interface module 200 receives the write status packet, it sends the write feedback packet via the SPI_MISO signal line. The write feedback packet starts with a second identifier and includes the status information contained in the write status packet.

As shown in FIG. 2, four embodiments of write command packets are provided:

The write command packet may include a first identifier and a write command data field, starting with the first identifier.

The write command packet may also include a first identifier, a write command length field, and a write command data field, starting with the first identifier.

The write command packet may also include a first identifier, a write command data field, and a write command checksum, starting with the first identifier.

The write command packet may also include a first identifier, a write command length field, a write command data field, and a write command checksum, starting with the first identifier.

The first identifier, write command length field (if present), write command data field, and write command checksum (if present) included in the write command packet consist of binary bit sequences. The present disclosure does not limit the length of these binary bit sequences for the first identifier, write command length field (if present), write command data field, or write command checksum (if present).

It should be noted that the present disclosure does not limit the format of the write command packet, meaning the write command packet format in the present disclosure is not restricted to the four embodiments shown in FIG. 2. The SPI master controller 100 and the SPI interface module 200 may agree on other write command packet formats.

In the present disclosure, the SPI interface module 200 receiving the write command packet refers to the data received by the SPI interface module 200 from the SPI_MOSI signal line reaching the length of the write command packet. In the present disclosure, the data received by the SPI interface module 200 from the SPI_MOSI signal line reaching the length of the write command packet means the SPI interface module 200 has received a complete write command packet. As shown in FIG. 2, the write command packet may include a write command length field. The SPI interface module 200 can determine whether the received data has reached the length of the write command packet (i.e., whether a complete write command packet has been received) based on the agreement with the SPI master controller 100 and the write command length field (or partially based on the write command length field), as illustrated in FIG. 2. The write command packet may also omit the write command length field. In such cases, the SPI interface module 200 determines whether the received data has reached the length of the write command packet (i.e., whether a complete write command packet has been received) based on the agreement with the SPI master controller 100 (which is not based on the write command length field).

When the write command packet includes a write command packet checksum, the SPI interface module 200 is considered to have received the write command packet when the data received from the SPI_MOSI signal line reaches the length of the write command packet and the write command packet checksum is verified as correct. The present disclosure does not restrict the type of write command packet checksum. The SPI interface module 200 and the SPI master controller 100 may agree on a checksum, such as using common CRC codes as the write command packet checksum. In the present disclosure, the write command packet checksum can be an error-detecting code or an error-correcting code. Error-detecting codes, like CRC codes, only detect errors, while error-correcting codes can both detect and correct errors.

The SPI master controller 100 drives the SPI_CK signal line and generates clock edges on it. The SPI master controller 100 samples data on the SPI_MISO signal line at the rising or falling clock edges of the SPI_CK signal line. The SPI interface module 200 samples data on the SPI_MOSI signal line at the rising or falling clock edges of the SPI_CK signal line, enabling bidirectional data transmission between the SPI master controller 100 and the SPI interface module 200.

The present disclosure does not limit the sampling of data on the SPI_MISO and SPI_MOSI signal lines to either the rising or falling clock edge of the SPI_CK signal line. In the embodiments described below, the data on the SPI_MISO and SPI_MOSI signal lines is sampled at the rising clock edge of the SPI_CK signal line, meaning the rising clock edge of the SPI_CK signal line serves as the sampling clock edge in these embodiments. In other embodiments of the present disclosure, the data on the SPI_MISO and SPI_MOSI signal lines may also be sampled at the falling clock edge of the SPI_CK signal line, where the falling clock edge of the SPI_CK signal line acts as the sampling clock edge.

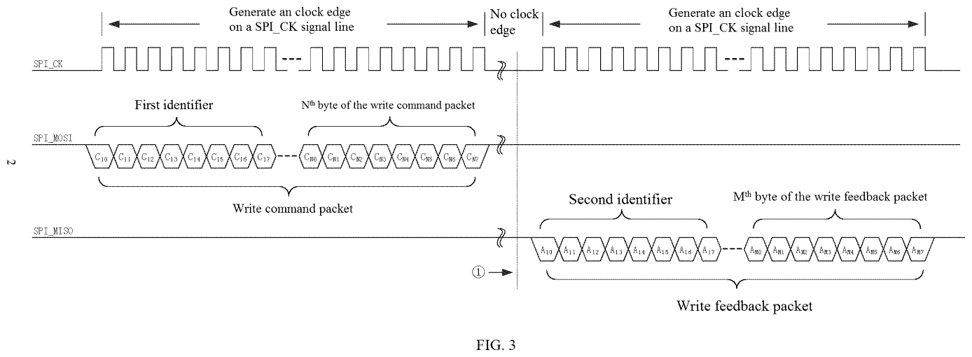

As shown in FIG. 3, the SPI master controller 100 generates a clock edge on the SPI_CK signal line while driving the SPI_MOSI signal line to send a write command packet to the SPI interface module 200. The write command packet consists of N bytes, each being 8-bit binary data. The first byte is the first identifier, represented as C₁₀, C₁₁ . . . C₁₇ in 8-bit binary data, and the N^{th} byte of the write command packet is its last byte, with its 8-bit binary data represented as C_{N0}, C_{N1} . . . C_{N7}.

The SPI interface module 200 samples the data on the SPI_MOSI signal line at the rising clock edge of the SPI_CK signal line to receive the write command packet. After the SPI interface module 200 samples C_{N7} bits, the data received from the SPI_MOSI signal line reaches the length of the write command packet, and the SPI interface module 200 successfully receives the write command packet.

Upon receiving the write command packet from the SPI_MOSI signal line, the SPI interface module 200 sends it to the functional module 300. In the present disclosure, the SPI interface module 200 may modify, add, or delete content in the write command packet when transmitting it to the functional module 300, as the present disclosure imposes no restrictions or regulations on this process.

The functional module 300 receives the write command packet and executes the write command. Upon completing the write command, the functional module 300 returns a write status packet to the SPI interface module 200.

At moment \textcircled{1}, the SPI interface module 200 receives a write status packet. The SPI master controller 100 generates a clock edge on the SPI_CK signal line. The SPI interface module 200 drives the SPI_MISO signal line and sends a write feedback packet via the SPI_MISO signal line. The SPI master controller 100 samples the data on the SPI_MISO signal line at the rising clock edge of the SPI_CK signal line to read the write feedback packet. The write feedback packet starts with a second identifier and includes the status information contained in the write status packet. The status information in the write status packet may indicate write success or write failure, or other status information.

The write feedback packet contains M bytes, each being 8-bit binary data. The first byte is the second identifier, represented as A₁₀, A₁₁ . . . A₁₇ for its 8-bit binary data. The M^{th} byte of the write feedback packet is its last byte, with its 8-bit binary data represented as A_{M0}, A_{M1} . . . A_{M7}.

For clarity, in the embodiment shown in FIG. 3 and the following descriptions of the present disclosure, each byte is described as 8-bit binary data. However, the present disclosure does not limit the number of bits per byte, which may also be of other bit lengths.

In the embodiment shown in FIG. 3, the first and second identifiers are one byte in length, and the write command packet and write feedback packet are integer multiples of bytes in length. For clarity, in the following descriptions of the present disclosure, the first to eighth identifiers are one byte in length, and the write command packet, read command packet, write feedback packet (including write success feedback packet and write failure feedback packet), and read feedback packet (including read success feedback packet and read failure feedback packet) are integer multiples of bytes in length. However, the present disclosure does not restrict the first to eighth identifiers to one byte in length or to integer multiples of bytes in length, nor does it limit the write command packet, read command packet, write feedback packet (including write success feedback packet and write failure feedback packet), or read feedback packet (including read success feedback packet and read failure feedback packet) to integer multiples of bytes in length.

In the interval labeled “No Clock Edge,” the SPI master controller 100 does not generate a sampling clock edge on the SPI_CK signal line. In FIG. 3 and subsequent embodiments of the present disclosure, the levels on the SPI_MOSI and SPI_MISO signal lines remain unchanged during the “No Clock Edge” interval. The present disclosure does not restrict the levels on the SPI_MOSI and SPI_MISO signal lines during the “No Clock Edge” interval; these levels may also change. However, since sampling of data on the SPI_MOSI and SPI_MISO signal lines occurs only at the sampling clock edges on the SPI_CK signal line (in the embodiment shown in FIG. 3, the sampling clock edge is the rising edge of the clock), level changes on the SPI_MOSI and SPI_MISO signal lines during the “No Clock Edge” interval will not be sampled or received.

In the embodiment shown in FIG. 3, the SPI master controller 100 generates a clock edge on the SPI_CK signal line while driving the SPI_MOSI signal line. When sending a write command packet via the SPI_MOSI signal line, the SPI interface module 200 has no write feedback packet to transmit. At this time, the SPI interface module 200 drives the SPI_MISO signal line to a high level. During this period, the SPI interface module 200 of the present disclosure may also drive the SPI_MISO signal line to a low level or a varying level. However, the SPI interface module 200 must ensure that the level or varying level it drives on the SPI_MISO signal line, if sampled by the SPI master controller 100 at the sampling clock edge on the SPI_CK signal line (in the embodiment shown in FIG. 3, the sampling clock edge is the rising edge of the clock), is not recognized as the second identifier. Taking the embodiment in FIG. 3 as an example, since the SPI interface module 200 drives the SPI_MISO signal line to a high level during this period (sampled as consecutive binary bits 1), to avoid being recognized as the second identifier, the value of the second identifier should not be 0xFF.

In the embodiment shown in FIG. 3, the SPI master controller 100 generates a clock edge on the SPI_CK signal line, and the SPI interface module 200 drives the SPI_MISO signal line. When sending a write feedback packet via the SPI_MISO signal line, the SPI master controller 100 has no write command packet to transmit. At this time, the SPI master controller 100 drives the SPI_MOSI signal line to a high level. During this period, the SPI master controller 100 of the present disclosure may also drive the SPI_MOSI signal line to a low level or a varying level. However, the SPI master controller 100 must ensure that the level or varying level it drives on the SPI_MOSI signal line, if sampled by the SPI interface module 200 at the sampling clock edge on the SPI_CK signal line (in the embodiment shown in FIG. 3, the sampling clock edge is the rising edge of the clock), is not recognized as the first identifier. Taking the embodiment in FIG. 3 as an example, since the SPI master controller 100 drives the SPI_MOSI signal line to a high level during this period (sampled as consecutive binary bits 1), to avoid being recognized as the first identifier, the value of the first identifier should not be 0xFF.

The SPI interface module 200 can connect to the SPI master controller 100 not only through the SPI_CK signal line, SPI_MOSI signal line, and SPI_MISO signal line but also via the SPI_CSN signal line. The SPI master controller 100 drives the SPI_CSN signal line, SPI_CK signal line, and SPI_MOSI signal line, while the SPI interface module 200 receives these signal lines. Conversely, the SPI interface module 200 drives the SPI_MISO signal line, and the SPI master controller 100 receives it. The SPI_CSN signal line serves as a selection signal; in the SPI protocol, data transmission occurs only when the SPI_CSN signal line is low. One SPI master controller 100 can connect to multiple SPI interface modules 200, sharing the SPI_CK, SPI_MOSI, and SPI_MISO signal lines among them. However, each SPI interface module 200 has an independent SPI_CSN signal line input. When the SPI_CSN signal line of an SPI interface module 200 is high, that SPI interface module 200 does not drive the SPI_MISO signal line (the driver output of the SPI interface module 200 connected to the SPI_MISO signal line is in a Hi-Z state). An SPI interface module 200 drives the SPI_MISO signal line only when its SPI_CSN signal line is low. When one SPI master controller 100 connects to multiple SPI interface modules 200, only one module's SPI_CSN signal line is low at any given time, preventing conflicts caused by multiple SPI interface modules 200 driving the SPI_MISO signal line simultaneously.

When an SPI master controller 100 connects to only one SPI interface module 200, that module can drive the SPI_MISO signal line at any time without causing conflicts. In this scenario, the SPI master controller 100 and the SPI interface module 200 may not require an SPI_CSN signal line. That is, when one SPI master controller 100 connects to only one SPI interface module 200, they can be linked solely through the SPI_CK, SPI_MOSI, and SPI_MISO signal lines. The description of the embodiment shown in FIG. 3 corresponds to this case.

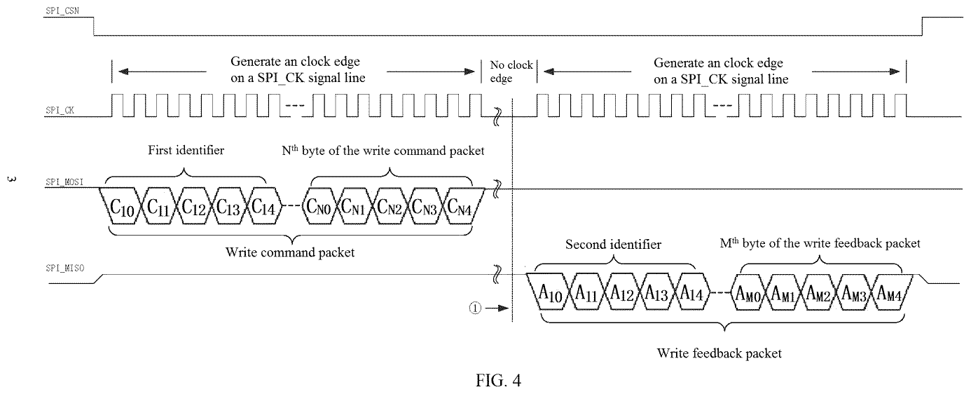

As shown in FIG. 4, an embodiment is presented where an SPI_CSN signal line exists between the SPI master controller 100 and the SPI interface module 200. The embodiment depicted in FIG. 4 describes the same process as the one shown in FIG. 3. Specifically, the SPI master controller 100 generates a clock edge on the SPI_CK signal line and sends a write command packet to the SPI interface module 200 via the SPI_MOSI signal line. Upon receiving the write command packet from the SPI_MOSI signal line, the SPI interface module 200 forwards it to the functional module 300. The functional module 300 receives the write command packet and executes the write command. After completing the write command, the functional module 300 returns a write status packet to the SPI interface module 200. At moment \textcircled{1}, the SPI interface module 200 receives the write status packet. The SPI master controller 100 then generates a clock edge on the SPI_CK signal line and reads the write feedback packet from the SPI interface module 200 via the SPI_MISO signal line. Before sending the write command packet to the SPI interface module 200 via the SPI_MOSI signal line, the SPI master controller 100 drives the SPI_CSN signal line low. After reading the write feedback packet sent by the SPI interface module 200 through the SPI_MISO signal line, it drives the SPI_CSN signal line high. During the “no clock edge” period, the SPI_CSN signal line remains low.

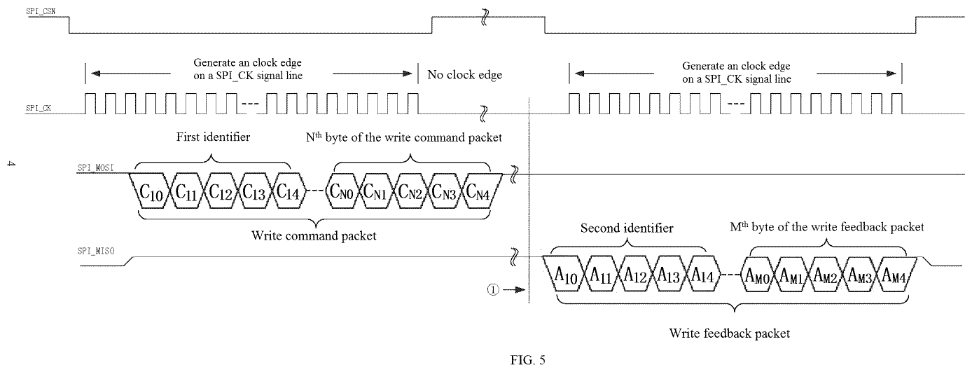

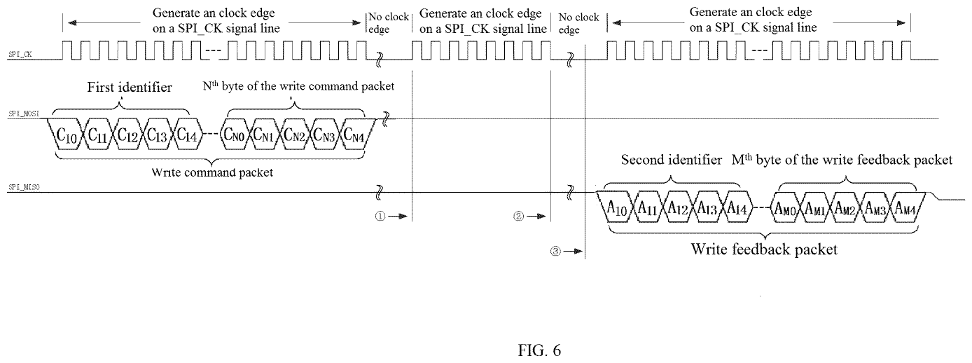

As shown in FIG. 5, another embodiment is presented where an SPI_CSN signal line exists between the SPI master controller 100 and the SPI interface module 200. The embodiment depicted in FIG. 5 describes the same process as the one shown in FIG. 3. Specifically, the SPI master controller 100 generates a clock edge on the SPI_CK signal line and sends a write command packet to the SPI interface module 200 via the SPI_MOSI signal line. Upon receiving the write command packet from the SPI_MOSI signal line, the SPI interface module 200 forwards it to the functional module 300. The functional module 300 receives the write command packet and executes the write command. After completing the write command, the functional module 300 returns a write status packet to the SPI interface module 200. At moment \textcircled{1}, the SPI interface module 200 receives the write status packet. The SPI master controller 100 then generates a clock edge on the SPI_CK signal line and reads the write feedback packet from the SPI interface module 200 via the SPI_MISO signal line. Before sending the write command packet to the SPI interface module 200 via the SPI_MOSI signal line, the SPI master controller 100 drives the SPI_CSN signal line low. During the “no clock edge” period after sending the write command packet, the SPI master controller 100 drives the SPI_CSN signal line high. Before generating a clock edge on the SPI_CK signal line to read the write feedback packet sent by the SPI interface module 200 through the SPI_MISO signal line, the SPI master controller 100 drives the SPI_CSN signal line low. After reading the write feedback packet, it drives the SPI_CSN signal line high.

When an SPI master controller 100 is connected to only one SPI interface module 200, there may be no SPI_CSN signal line between the SPI master controller 100 and the SPI interface module 200. The description of the embodiment shown in FIG. 3 in the present disclosure corresponds to this scenario. FIGS. 4 and 5 above describe embodiments where an SPI_CSN signal line exists between the SPI master controller 100 and the SPI interface module 200, based on the embodiment shown in FIG. 3. In the following description of the present disclosure, only the case where no SPI_CSN signal line exists between the SPI master controller 100 and the SPI interface module 200 is described. Based on the embodiments shown in FIGS. 4 and 5, it is easy to extend to the case where an SPI_CSN signal line exists between the SPI master controller 100 and the SPI interface module 200. The following description of the present disclosure will not reiterate the case where an SPI_CSN signal line exists between the SPI master controller 100 and the SPI interface module 200. Whether or not an SPI_CSN signal line exists between the SPI master controller 100 and the SPI interface module 200, both cases fall within the scope of protection of the present disclosure.

The SPI master controller 100 generates clock edges on the SPI_CK signal line and reads the write feedback packet via the SPI_MISO signal line. If the SPI interface module 200 does not receive the write status packet, the SPI interface module 200 sends data that cannot be recognized as the write feedback packet to the SPI master controller 100 through the SPI_MISO signal line.

Taking FIG. 6 as an example, the SPI master controller 100 generates clock edges on the SPI_CK signal line and sends the write command packet to the SPI interface module 200 via the SPI_MOSI signal line. Upon receiving the write command packet from the SPI_MOSI signal line, the SPI interface module 200 sends it to the functional module 300. The functional module 300 receives and executes the write command. After completing the write command, the functional module 300 returns a write status packet to the SPI interface module 200. At moment \textcircled{3}, the SPI interface module 200 receives the write status packet. However, before moment \textcircled{3} when the SPI interface module 200 receives the write status packet, between moment \textcircled{1} and moment \textcircled{2}, the SPI master controller 100 generates clock edges on the SPI_CK signal line. In the embodiment shown in FIG. 6, the SPI interface module 200 drives the SPI_MISO signal line to a high level. During this period, the SPI interface module 200 may also drive the SPI_MISO signal line to a low level or a varying level. However, the SPI interface module 200 must ensure that the level or varying level it drives on the SPI_MISO signal line, if sampled by the clock edges generated by the SPI master controller 100 on the SPI_CK signal line (in the embodiment of FIG. 3, the sampling clock edge is the rising edge), is not recognized as the second identifier. That is, when the SPI interface module 200 has not received the write status packet, if the SPI master controller 100 generates clock edges on the SPI_CK signal line, the SPI interface module 200 sends data via the SPI_MISO signal line that cannot be recognized as the write feedback packet to the SPI master controller 100. After the SPI interface module 200 receives the write status packet at moment \textcircled{3}, the SPI master controller 100 generates clock edges on the SPI_CK signal line and reads the write feedback packet from the SPI interface module 200 via the SPI_MISO signal line.

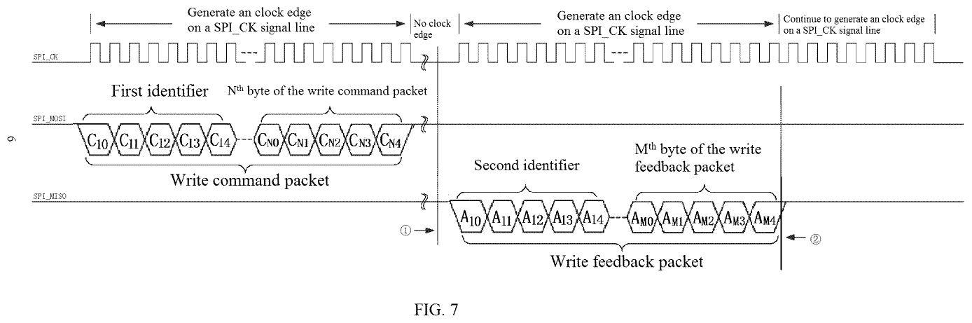

In the embodiment shown in FIG. 7, the SPI master controller 100 generates a clock edge on the SPI_CK signal line and sends a write command packet to the SPI interface module 200 via the SPI_MOSI signal line. Upon receiving the write command packet from the SPI_MOSI signal line, the SPI interface module 200 forwards it to the functional module 300. The functional module 300 receives and executes the write command. After completing the write command, the functional module 300 returns a write status packet to the SPI interface module 200. At moment \textcircled{1}, the SPI interface module 200 receives the write status packet. The SPI master controller 100 then generates a clock edge on the SPI_CK signal line and reads the write feedback packet from the SPI interface module 200 via the SPI_MISO signal line. At moment \textcircled{2}, the SPI master controller 100 finishes reading the write feedback packet, and the SPI interface module 200 completes sending it. The SPI master controller 100 continues generating clock edges on the SPI_CK signal line, during which the SPI interface module 200 drives the SPI_MISO signal line to a high level. Alternatively, it may drive it to a low or varying level, but the SPI interface module 200 must ensure that the driven level or its variation, if sampled by the clock edge (rising edge in the embodiment of FIG. 3) on SPI_CK by the master controller 100, is not recognized as the second identifier.

The SPI interface module 200 may also include a timeout timer. This timer starts counting upon receiving the write command packet or sending it to the functional module 300, or begins at a preset time upon receiving the packet. If the SPI interface module 200 fails to receive the write status packet before timeout, and the SPI master controller 100 subsequently generates a clock edge on the SPI_CK signal line to read the write feedback packet via SPI_MISO, the SPI interface module 200 sends the write feedback packet to the master controller 100 via SPI_MISO. The write feedback packet contains status information agreed upon between the SPI master controller 100 and the SPI interface module 200. This status information may include write command packet timeout details or other predefined status information.

In the present disclosure, the SPI master controller 100 generates clock edges on the SPI_CK signal line and sends the write command packet to the SPI interface module 200 via the SPI_MOSI signal line. Upon receiving the write command packet from the SPI_MOSI signal line, the SPI interface module 200 forwards it to the functional module 300. The functional module 300 receives and executes the write command. After completing the write command, the functional module 300 returns a write status packet to the SPI interface module 200. Subsequently, the SPI master controller 100 generates clock edges on the SPI_CK signal line and reads the write feedback packet via the SPI_MISO signal line. Before the SPI master controller 100 reads the write feedback packet, if it drives the SPI_MOSI signal line to send command packets (including the write command packet and the read command packet described later in the present disclosure), the SPI interface module 200 will not accept these command packets sent prior to reading the write feedback packet. After the SPI master controller 100 reads the write feedback packet—i.e., after the SPI interface module 200 sends the write feedback packet via the SPI_MISO signal line—the SPI interface module 200 can continue receiving subsequent command packets, which include the write command packet and the read command packet described later in the present disclosure.

In the present disclosure, the write feedback packet can be categorized into a write success feedback packet and a write failure feedback packet. When the SPI master controller 100 generates clock edges on the SPI_CK signal line and reads the write feedback packet via the SPI_MISO signal line, if the SPI interface module 200 receives the write status packet and the status information contained therein indicates success, the SPI interface module 200 sends the write success feedback packet via the SPI_MISO signal line, starting with a third identifier. Conversely, if the SPI interface module 200 receives the write status packet and the status information indicates failure, it sends the write failure feedback packet via the SPI_MISO signal line, starting with a fourth identifier.

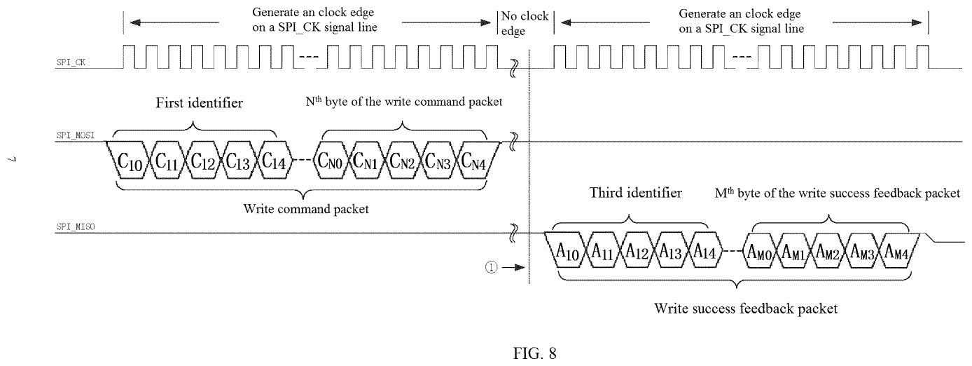

As shown in FIG. 8, the SPI master controller 100 generates clock edges on the SPI_CK signal line and sends the write command packet to the SPI interface module 200 via the SPI_MOSI signal line. Upon receiving the write command packet from the SPI_MOSI signal line, the SPI interface module 200 forwards it to the functional module 300. The functional module 300 receives and executes the write command. After completing the write command, it returns a write status packet to the SPI interface module 200. At moment \textcircled{1}, the SPI interface module 200 receives the write status packet, which contains status information indicating success. When the SPI master controller 100 generates clock edges on the SPI_CK signal line and reads the write feedback packet from the SPI interface module 200 via the SPI_MISO signal line, the SPI interface module 200 drives the SPI_MISO signal line to transmit the write success feedback packet to the SPI master controller 100, starting with a third identifier.

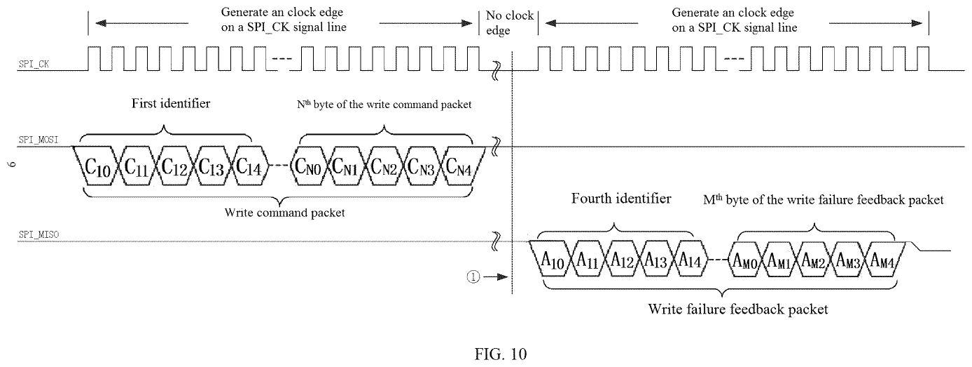

As shown in FIG. 10, the SPI master controller 100 generates a clock edge on the SPI_CK signal line and sends a write command packet to the SPI interface module 200 via the SPI_MOSI signal line. Upon receiving the write command packet from the SPI_MOSI signal line, the SPI interface module 200 forwards it to the functional module 300. The functional module 300 receives and executes the write command. Upon completion, it returns a write status packet to the SPI interface module 200. At moment \textcircled{1}, the SPI interface module 200 receives the write status packet, which contains status information indicating failure. When the SPI master controller 100 generates a clock edge on the SPI_CK signal line and reads the write feedback packet from the SPI interface module 200 via the SPI_MISO signal line, the SPI interface module 200 drives the SPI_MISO signal line to send a write failure feedback packet to the SPI master controller 100. The write failure feedback packet starts with a fourth identifier.

In the present disclosure, the third identifier differs from the fourth identifier. When the SPI master controller 100 reads the write feedback packet, it can determine whether the packet is a write success feedback packet or a write failure feedback packet based on whether it starts with the third or fourth identifier. Therefore, the write success feedback packet may only contain the third identifier, and the write failure feedback packet may only contain the fourth identifier, enabling the SPI master controller 100 to distinguish between them.

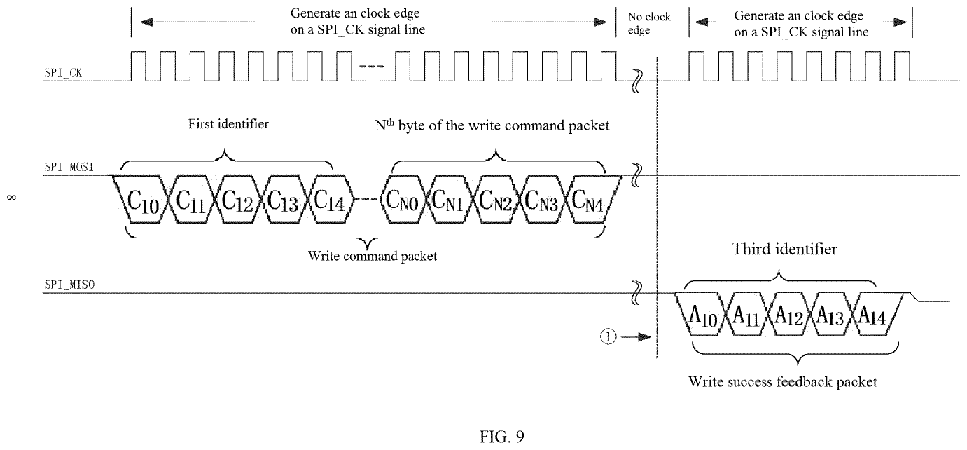

As shown in FIG. 9, the SPI master controller 100 generates a clock edge on the SPI_CK signal line and sends a write command packet to the SPI interface module 200 via the SPI_MOSI signal line. Upon receiving the write command packet from the SPI_MOSI signal line, the SPI interface module 200 forwards it to the functional module 300. The functional module 300 receives and executes the write command. Upon completion, it returns a write status packet to the SPI interface module 200. At moment \textcircled{1}, the SPI interface module 200 receives the write status packet, which contains status information indicating success. When the SPI master controller 100 generates a clock edge on the SPI_CK signal line and reads the write feedback packet from the SPI interface module 200 via the SPI_MISO signal line, the SPI interface module 200 drives the SPI_MISO signal line to send a write success feedback packet to the SPI master controller 100. The write success feedback packet contains only the third identifier.

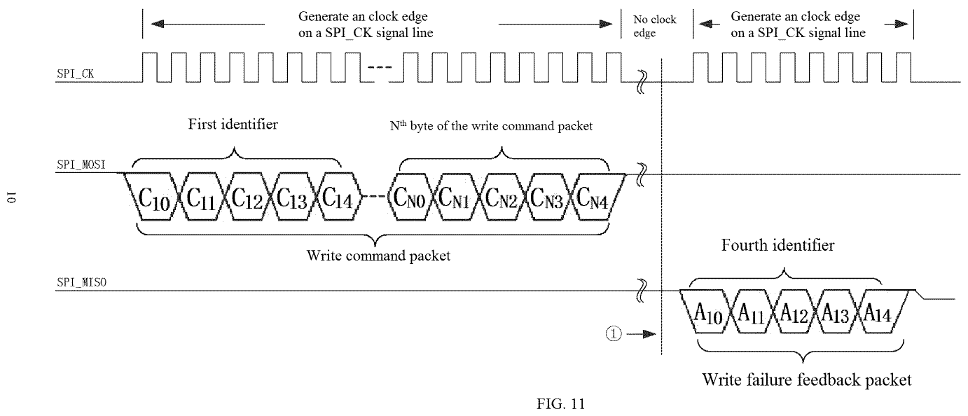

As shown in FIG. 11, the SPI master controller 100 generates a clock edge on the SPI_CK signal line and sends a write command packet to the SPI interface module 200 via the SPI_MOSI signal line. Upon receiving the write command packet from the SPI_MOSI signal line, the SPI interface module 200 forwards it to the functional module 300. The functional module 300 receives and executes the write command. After completing the write command, the functional module 300 returns a write status packet to the SPI interface module 200. At moment \textcircled{1}, the SPI interface module 200 receives the write status packet, which contains status information indicating failure. When the SPI master controller 100 generates a clock edge on the SPI_CK signal line and reads the write feedback packet from the SPI interface module 200 via the SPI_MISO signal line, the SPI interface module 200 drives the SPI_MISO signal line to send a write failure feedback packet to the SPI master controller 100. This write failure feedback packet contains only the fourth identifier.

The SPI interface module 200 may also include a timeout timer. The timeout timer starts counting upon receiving the write command packet or sending it to the functional module 300, or at a preset time upon receiving the write command packet. If the SPI interface module 200 does not receive the write status packet before timeout, and if the SPI master controller 100 subsequently generates a clock edge on the SPI_CK signal line to read the write feedback packet via the SPI_MISO signal line, the SPI interface module 200 sends a write failure feedback packet to the SPI master controller 100 via the SPI_MISO signal line. The write feedback packet contains status information agreed upon between the SPI master controller 100 and the SPI interface module 200. This status information may include write command packet timeout details or other predefined status information.

### SPI Data Read Method

The SPI master controller 100 generates a clock edge on the SPI_CK signal line and sends a read command packet to the SPI interface module 200 via the SPI_MOSI signal line. The read command packet starts with a fifth identifier.

Upon receiving the read command packet from the SPI_MOSI signal line, the SPI interface module 200 forwards it to the functional module 300.

The functional module 300 receives the read command packet and executes the read command. Upon completion, it returns a read data packet to the SPI interface module 200.

The SPI master controller 100 generates a clock edge on the SPI_CK signal line and reads the read feedback packet via the SPI_MISO signal line.

When the SPI interface module 200 receives the read data packet, it sends the read feedback packet via the SPI_MISO signal line. The read feedback packet starts with a sixth identifier and contains the read data from the read data packet.

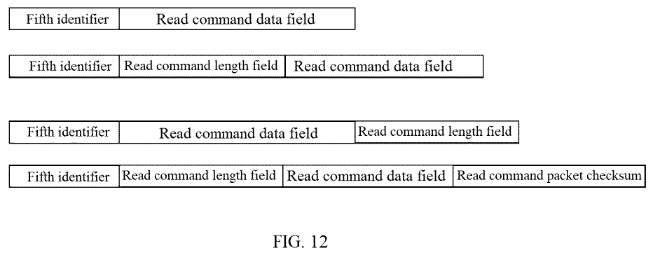

As shown in FIG. 12, four examples of read command packets are provided:

A read command packet may include a fifth identifier and a read command data field, starting with the fifth identifier.

A read command packet may also include a fifth identifier, a read command length field, and a read command data field, starting with the fifth identifier.

The read command packet may also include a fifth identifier, a read command data field, and a read command checksum, starting with the fifth identifier.

The read command packet may also include a fifth identifier, a read command length field, a read command data field, and a read command checksum, starting with the fifth identifier.

The fifth identifier, read command length field (if present), read command data field, and read command checksum (if present) included in the read command packet are composed of binary bit sequences. The present disclosure does not limit the length of the binary bit sequences for the fifth identifier, read command length field (if present), read command data field, or read command checksum (if present).

It should be noted that the present disclosure does not limit the format of the read command packet, meaning the read command packet format in the present disclosure is not limited to the four read command packet embodiments shown in FIG. 12. The SPI master controller 100 and the SPI interface module 200 may agree on other read command packet formats.

In the present disclosure, the SPI interface module 200 receiving the read command packet means that the data received by the SPI interface module 200 from the SPI_MOSI signal line reaches the length of the read command packet. In the present disclosure, the data received by the SPI interface module 200 from the SPI_MOSI signal line reaching the length of the read command packet means the SPI interface module 200 has received a complete read command packet. As shown in FIG. 12, the read command packet may include a read command length field. The SPI interface module 200 can determine whether the received data has reached the length of the read command packet (i.e., whether a complete read command packet has been received) based on an agreement with the SPI master controller 100, partially or fully relying on the read command length field. As shown in FIG. 12, the read command packet may also exclude the read command length field. In such cases, the SPI interface module 200 determines whether the received data has reached the length of the read command packet (i.e., whether a complete read command packet has been received) based on an agreement with the SPI master controller 100 (which does not rely on the read command length field).

When the read command packet includes a read command packet checksum, the SPI interface module 200 is considered to have received the read command packet when the data received from the SPI_MOSI signal line reaches the length of the read command packet and the read command packet checksum is verified correctly. The present disclosure does not limit the type of read command packet checksum. The SPI interface module 200 and the SPI master controller 100 may agree on a read command packet checksum, such as using a common CRC code as the read command packet checksum. In the present disclosure, the read command packet checksum can be an error-detecting code or an error-correcting code. Error-detecting codes only have error-detection capabilities, such as CRC codes, while error-correcting codes can both detect and correct errors.

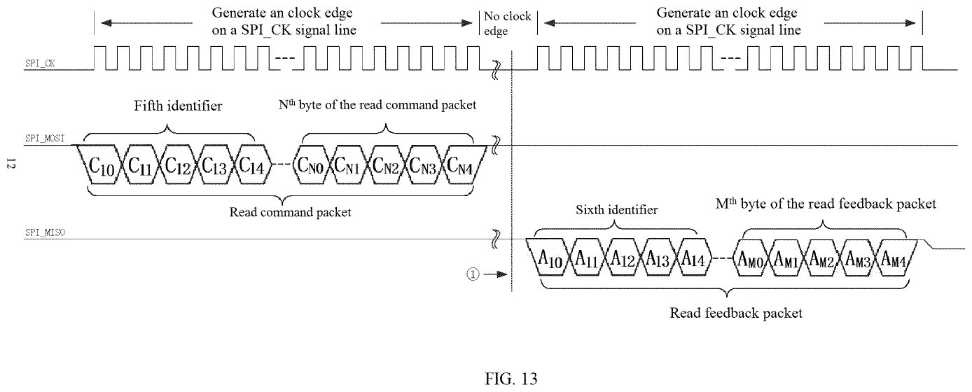

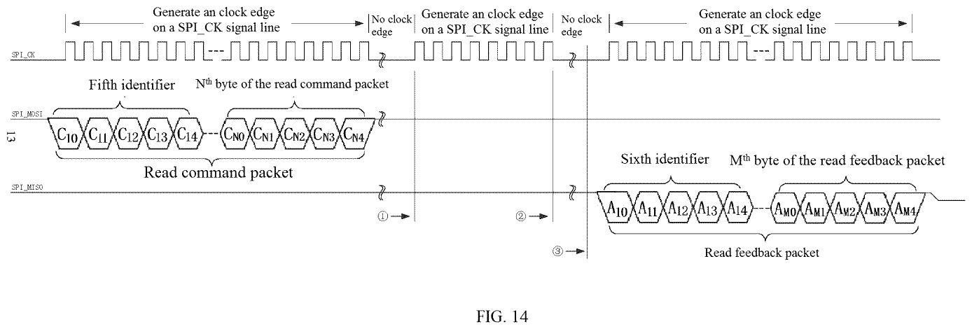

As shown in FIG. 13, the SPI master controller 100 generates a clock edge on the SPI_CK signal line while driving the SPI_MOSI signal line to send the read command packet to the SPI interface module 200 via the SPI_MOSI signal line. The read command packet contains N bytes, each being 8-bit binary data. The first byte is the fifth identifier, with its 8-bit binary data represented as C₁₀, C₁₁ . . . C₁₇. The N-th byte of the read command packet is its last byte, and its 8-bit binary data is represented as C_{N0}, C_{N1} . . . C_{N7}.

The SPI interface module 200 samples the data on the SPI_MOSI signal line at the rising clock edge of the SPI_CK signal line to receive the read command packet. When the SPI interface module 200 samples C_{N7} bits, the data received from the SPI_MOSI signal line reaches the length of the read command packet, and the SPI interface module 200 successfully receives the read command packet.

Upon receiving the read command packet from the SPI_MOSI signal line, the SPI interface module 200 sends it to the functional module 300. In the present disclosure, the SPI interface module 200 may modify, add, or delete content in the read command packet when transmitting it to the functional module 300, as this is not restricted or specified herein.

The functional module 300 receives the read command packet and executes the read command. Upon completion, it returns a read data packet to the SPI interface module 200.

At moment \textcircled{1}, the SPI interface module 200 receives the read data packet. The SPI master controller 100 generates a clock edge on the SPI_CK signal line, and the SPI interface module 200 drives the SPI_MISO signal line to send the read feedback packet via SPI_MISO. The SPI master controller 100 samples the data on the SPI_MISO signal line at the rising clock edge of SPI_CK to read the feedback packet, which starts with the sixth identifier and contains the read data included in the read data packet.

The read data includes data read from the functional module 300, status information generated by the functional module 300 during the read command execution, or both. The status information may indicate read success or failure, or other status details.

The read feedback packet contains M bytes, each byte being 8-bit binary data. The first byte is the sixth identifier, with its 8-bit binary data represented as A₁₀, A₁₁ . . . A₁₇. The M-th byte of the read feedback packet is its last byte, and its 8-bit binary data is represented as A_{M0}, A_{M1} . . . A_{M7}.

In the embodiment shown in FIG. 13, the SPI master controller 100 generates a clock edge on the SPI_CK signal line while driving the SPI_MOSI signal line. When sending a read command packet via the SPI_MOSI signal line, the SPI interface module 200 has no read feedback packet to transmit. During this time, the SPI interface module 200 drives the SPI_MISO signal line to a high level. Alternatively, the present disclosure allows the SPI interface module 200 to drive the SPI_MISO signal line to a low level or a varying level. However, the SPI interface module 200 must ensure that the driven level or varying level on the SPI_MISO signal line, if sampled by the master controller 100 at the clock edge on the SPI_CK signal line (in this embodiment, the sampling clock edge is the rising edge), is not recognized as the sixth identifier. Taking the embodiment in FIG. 13 as an example, since the SPI interface module 200 drives the SPI_MISO signal line to a high level (sampled as continuous binary bits ‘1’) during this period, to avoid being recognized as the sixth identifier, the value of the sixth identifier should not be 0xFF.

In the embodiment shown in FIG. 13, the SPI master controller 100 generates a clock edge on the SPI_CK signal line, while the SPI interface module 200 drives the SPI_MISO signal line to transmit a read feedback packet. During this time, the SPI master controller 100 has no read command packet to send and thus drives the SPI_MOSI signal line to a high level. Alternatively, the present disclosure allows the SPI master controller 100 to drive the SPI_MOSI signal line to a low level or a varying level. However, the SPI master controller 100 must ensure that the driven level or varying level on the SPI_MOSI signal line, if sampled by the SPI interface module 200 at the clock edge on the SPI_CK signal line (in this embodiment, the sampling clock edge is the rising edge), is not recognized as the fifth identifier. Taking the embodiment in FIG. 13 as an example, since the SPI master controller 100 drives the SPI_MOSI signal line to a high level (sampled as continuous binary bits ‘1’) during this period, to avoid being recognized as the fifth identifier, the value of the fifth identifier should not be 0xFF.

The SPI master controller 100 generates a clock edge on the SPI_CK signal line and reads the read feedback packet via the SPI_MISO signal line. If the SPI interface module 200 does not receive the read data packet, the SPI interface module 200 sends data that cannot be recognized as the read feedback packet to the SPI master controller 100 through the SPI_MISO signal line.

Taking FIG. 14 as an example, the SPI master controller 100 generates a clock edge on the SPI_CK signal line and sends the read command packet to the SPI interface module 200 via the SPI_MOSI signal line. Upon receiving the read command packet from the SPI_MOSI signal line, the SPI interface module 200 forwards it to the functional module 300. The functional module 300 receives and executes the read command. Upon completing the read command, the functional module 300 returns the read data packet to the SPI interface module 200. At moment \textcircled{3}, the SPI interface module 200 receives the read data packet. Before moment \textcircled{3}, between moments \textcircled{1} and \textcircled{2}, the SPI master controller 100 generates a clock edge on the SPI_CK signal line. In the embodiment shown in FIG. 14, the SPI interface module 200 drives the SPI_MISO signal line to a high level. During this period, the SPI interface module 200 may also drive the SPI_MISO signal line to a low level or a varying level. However, the SPI interface module 200 must ensure that the level or varying level it drives on the SPI_MISO signal line, if sampled by the clock edge (rising edge in FIG. 14) generated by the SPI master controller 100 on the SPI_CK signal line, is not recognized as the sixth identifier. That is, if the SPI interface module 200 has not received the read data packet and the SPI master controller 100 generates a clock edge on the SPI_CK signal line, the SPI interface module 200 sends data that cannot be recognized as the read feedback packet to the SPI master controller 100 via the SPI_MISO signal line. After the SPI interface module 200 receives the read data packet at moment \textcircled{3}, the SPI master controller 100 generates a clock edge on the SPI_CK signal line and reads the read feedback packet from the SPI interface module 200 through the SPI_MISO signal line.

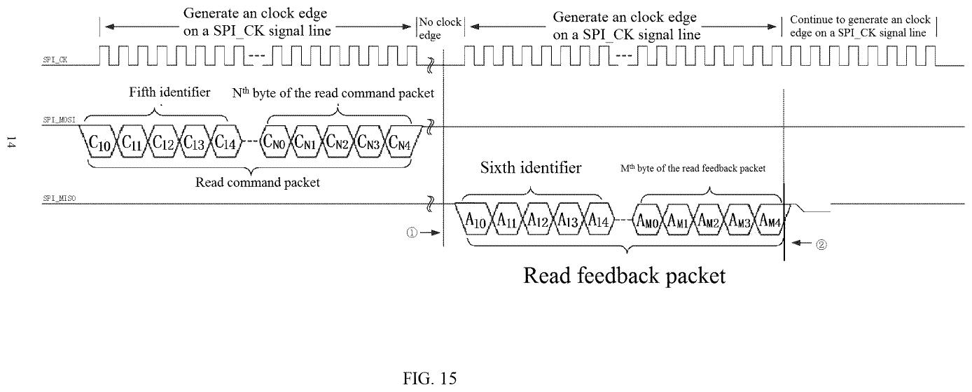

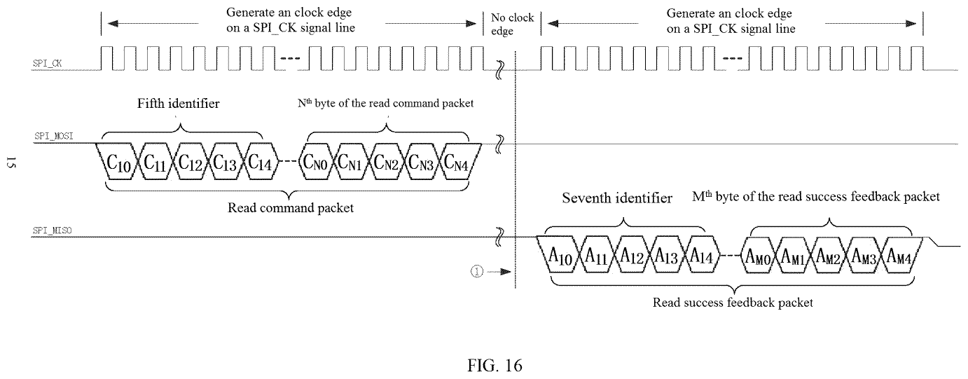

In the embodiment shown in FIG. 15, the SPI master controller 100 generates clock edges on the SPI_CK signal line and sends the read command packet to the SPI interface module 200 via the SPI_MOSI signal line. Upon receiving the read command packet from the SPI_MOSI signal line, the SPI interface module 200 sends the read command packet to the functional module 300. The functional module 300 receives and executes the read command. After completing the read command, the functional module 300 returns the read data packet to the SPI interface module 200. At moment \textcircled{1}, the SPI interface module 200 receives the read data packet. The SPI master controller 100 generates clock edges on the SPI_CK signal line and reads the read feedback packet from the SPI interface module 200 via the SPI_MISO signal line. At moment \textcircled{2}, the SPI master controller 100 finishes reading the read feedback packet, and the SPI interface module 200 completes sending the read feedback packet. The SPI master controller 100 continues to generate clock edges on the SPI_CK signal line. During this time, the SPI interface module 200 drives the SPI_MISO signal line to a high level. Alternatively, the SPI interface module 200 may drive the SPI_MISO signal line to a low level or a varying level. However, the SPI interface module 200 must ensure that the driven level or varying level on the SPI_MISO signal line, if sampled by the clock edges (rising edges in the embodiment of FIG. 15) generated by the SPI master controller 100 on the SPI_CK signal line, is not recognized as the sixth identifier.

The SPI interface module 200 may further include a timeout timer. The timeout timer starts counting upon receiving the read command packet or sending the read command packet to the functional module 300, or begins counting at a preset time upon receiving the read command packet. If the SPI interface module 200 fails to receive the read data packet before the timeout, and if the SPI master controller 100 generates clock edges on the SPI_CK signal line after the timeout to read the read feedback packet via the SPI_MISO signal line, the SPI interface module 200 sends the read feedback packet to the SPI master controller 100 via the SPI_MISO signal line. The read feedback packet contains status information agreed upon between the SPI master controller 100 and the SPI interface module 200. This status information may include read command packet timeout details or other predefined status information.

In the present disclosure, the SPI master controller 100 generates clock edges on the SPI_CK signal line and sends the read command packet to the SPI interface module 200 via the SPI_MOSI signal line. Upon receiving the read command packet from the SPI_MOSI signal line, the SPI interface module 200 sends the read command packet to the functional module 300. The functional module 300 receives and executes the read command. After completing the read command, the functional module 300 returns the read data packet to the SPI interface module 200. Subsequently, the SPI master controller 100 generates clock edges on the SPI_CK signal line and reads the read feedback packet via the SPI_MISO signal line. Before the SPI master controller 100 reads the read feedback packet, if the SPI master controller 100 drives the SPI_MOSI signal line to send a command packet (including a read command packet and a write command packet), the SPI interface module 200 will not receive the command packet sent before the SPI master controller 100 reads the read feedback packet. After the SPI master controller 100 reads the read feedback packet, i.e., after the SPI interface module 200 sends the read feedback packet via the SPI_MISO signal line, the SPI interface module 200 can continue to receive subsequent command packets, which include read command packets and write command packets.

In the present disclosure, the read feedback packet can be divided into a read success feedback packet and a read failure feedback packet. When the SPI master controller 100 generates a clock edge on the SPI_CK signal line and reads the read feedback packet via the SPI_MISO signal line, if the SPI interface module 200 receives the read data packet and the status information contained in the read data packet indicates success, the SPI interface module 200 sends the read success feedback packet via the SPI_MISO signal line, starting with a seventh identifier. If the SPI interface module 200 receives the read data packet and the status information contained in the read data packet indicates failure, the SPI interface module 200 sends the read failure feedback packet via the SPI_MISO signal line, starting with an eighth identifier.

As shown in FIG. 16, the SPI master controller 100 generates a clock edge on the SPI_CK signal line and sends a read command packet to the SPI interface module 200 via the SPI_MOSI signal line. After the SPI interface module 200 receives the read command packet from the SPI_MOSI signal line, it forwards the read command packet to the functional module 300. The functional module 300 receives the read command packet and executes the read command. When the functional module 300 completes the read command, it returns a read data packet to the SPI interface module 200. At moment \textcircled{1}, the SPI interface module 200 receives the read data packet, and the status information contained in the read data packet indicates success. When the SPI master controller 100 generates a clock edge on the SPI_CK signal line and reads the read feedback packet from the SPI interface module 200 via the SPI_MISO signal line, the SPI interface module 200 drives the SPI_MISO signal line to send the read success feedback packet to the SPI master controller 100, starting with a seventh identifier.

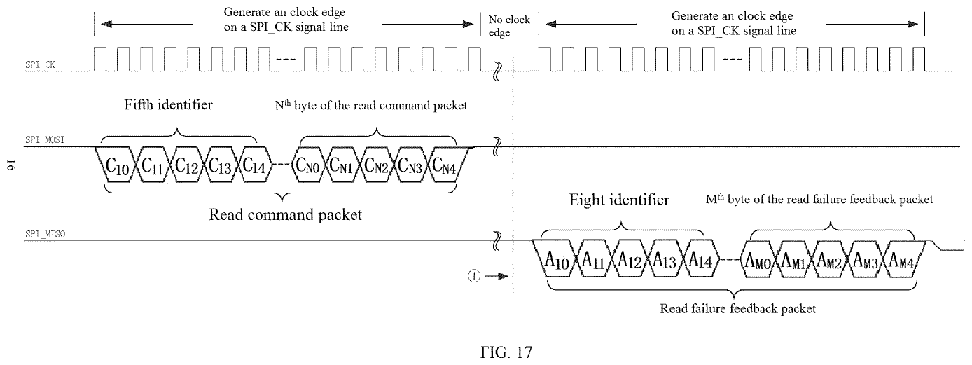

As shown in FIG. 17, the SPI master controller 100 generates a clock edge on the SPI_CK signal line and sends a read command packet to the SPI interface module 200 via the SPI_MOSI signal line. Upon receiving the read command packet from the SPI_MOSI signal line, the SPI interface module 200 forwards the read command packet to the functional module 300. The functional module 300 receives and executes the read command. Upon completion of the read command, the functional module 300 returns a read data packet to the SPI interface module 200. At moment \textcircled{1}, the SPI interface module 200 receives the read data packet, which contains status information indicating failure. When the SPI master controller 100 generates a clock edge on the SPI_CK signal line and reads the read feedback packet from the SPI interface module 200 via the SPI_MISO signal line, the SPI interface module 200 drives the SPI_MISO signal line to send a read failure feedback packet to the SPI master controller 100. The read failure feedback packet starts with an eighth identifier.

In the present disclosure, the seventh identifier differs from the eighth identifier. When the SPI master controller 100 reads the read feedback packet, it can determine whether the packet is a read success feedback packet or a read failure feedback packet based on whether the packet starts with the seventh identifier or the eighth identifier. The read success feedback packet starts with the seventh identifier and includes the data read from the functional module 300, whereas the read failure feedback packet may only contain the eighth identifier.

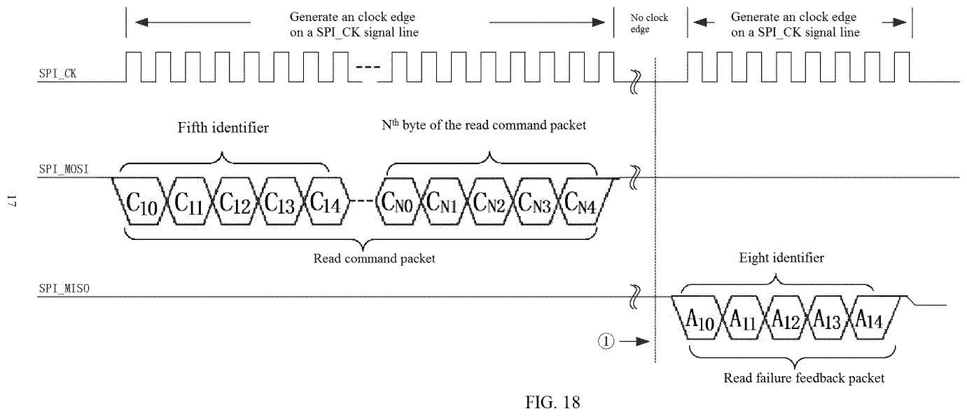

As shown in FIG. 18, the SPI master controller 100 generates a clock edge on the SPI_CK signal line and sends a read command packet to the SPI interface module 200 via the SPI_MOSI signal line. Upon receiving the read command packet from the SPI_MOSI signal line, the SPI interface module 200 forwards the read command packet to the functional module 300. The functional module 300 receives and executes the read command. Upon completion of the read command, the functional module 300 returns a read data packet to the SPI interface module 200. At moment \textcircled{1}, the SPI interface module 200 receives the read data packet, which contains status information indicating failure. When the SPI master controller 100 generates a clock edge on the SPI_CK signal line and reads the read feedback packet from the SPI interface module 200 via the SPI_MISO signal line, the SPI interface module 200 drives the SPI_MISO signal line to send a read failure feedback packet to the SPI master controller 100. The read failure feedback packet only contains the eighth identifier.

The SPI interface module 200 may further include a timeout timer, which starts timing upon receiving a read command packet or sending the read command packet to the functional module 300, or begins timing at a preset moment upon receiving the read command packet. If the SPI interface module 200 does not receive the read data packet before timeout, and if the SPI master controller 100 generates a clock edge on the SPI_CK signal line after timeout, the read feedback packet is read via the SPI_MISO signal line. The SPI interface module 200 sends a read failure feedback packet to the SPI master controller 100 through the SPI_MISO signal line. The read feedback packet contains status information, which is agreed upon between the SPI master controller 100 and the SPI interface module 200. The status information may include read command packet timeout information or other status information agreed upon by the SPI master controller 100 and the SPI interface module 200.

Although embodiments of the present disclosure have been shown and described above, it is to be understood that these embodiments are exemplary and should not be construed as limiting the present disclosure. Any variations, modifications, substitutions, and adaptations made by those skilled in the art within the scope of the present disclosure shall fall within the protection scope of the present disclosure.

What is claimed is:

1. An SPI data writing method, using an SPI interface system for data writing, and comprising:
providing the SPI interface system, wherein the SPI interface system comprises an SPI interface module and at least one functional module, the SPI interface module is connected to an SPI master controller via an SPI_CK signal line, an SPI_MOSI signal line and an SPI_MISO signal line, and the functional module is connected to the SPI interface module;
the SPI master controller generating a clock edge on the SPI_CK signal line and sending a write command packet to the SPI interface module via the SPI_MOSI signal line, wherein the write command packet starts with a first identifier;
upon receiving the write command packet from the SPI_MOSI signal line, the SPI interface module sending the write command packet to the functional module;
the functional module receiving the write command packet and executing a write command, and after completing the write command, the functional module returning a write status packet to the SPI interface module;
the SPI master controller generating a clock edge on the SPI_CK signal line and reading a write feedback packet via the SPI_MISO signal line; and
upon receiving the write status packet, the SPI interface module sending the write feedback packet via the SPI_MISO signal line, wherein the write feedback packet starts with a second identifier and contains status information comprised in the write status packet.

2. The SPI data writing method according to claim 1, wherein if the data received by the SPI interface module from the SPI_MOSI signal line reaches a length of the write command packet, the SPI interface module has received the write command packet.

3. The SPI data writing method according to claim 1, wherein the write command packet further comprises a write command packet checksum; and
if the data received by the SPI interface module from the SPI_MOSI signal line reaches the length of the write command packet and the write command packet checksum is verified correctly, the SPI interface module has received the write command packet.

4. The SPI data writing method according to claim 1, wherein the SPI master controller generates a clock edge on the SPI_CK signal line and reads the write feedback packet via the SPI_MISO signal line; and
if the SPI interface module does not receive the write status packet, the SPI interface module sends data that cannot be recognized as the write feedback packet to the SPI master controller via the SPI_MISO signal line.

5. The SPI data writing method according to claim 1, wherein the SPI interface module comprises a timeout timer;
when the SPI interface module does not receive the write status packet before timeout, if the SPI master controller generates a clock edge on the SPI_CK signal line after timeout, the write feedback packet is read via the SPI_MISO signal line; and
then the SPI interface module sends the write feedback packet to the SPI master controller via the SPI_MISO signal line.

6. The SPI data writing method according to claim 1, wherein the SPI master controller generates a clock edge on the SPI_CK signal line and sends the write command packet to the SPI interface module via the SPI_MOSI signal line; and
then the SPI master controller generates a clock edge on the SPI_CK signal line and reads the write feedback packet via the SPI_MISO signal line; and after the SPI interface module sends the write feedback packet via the SPI_MISO signal line, the SPI interface module can continue to receive subsequent command packets, wherein the subsequent command packets comprise write command packets and read command packets.

7. The SPI data writing method according to claim 1, wherein the write feedback packet is divided into a write success feedback packet and a write failure feedback packet;
the SPI master controller generates a clock edge on the SPI_CK signal line and reads the write feedback packet via the SPI_MISO signal line;
if the SPI interface module receives the write status packet and the status information contained in the write status packet indicates success, the SPI interface module sends the write success feedback packet via the SPI_MISO signal line, with the write success feedback packet starting with a third identifier; and
if the SPI interface module receives the write status packet and the status information contained in the write status packet indicates failure, the SPI interface module sends the write failure feedback packet via the SPI_MISO signal line, with the write failure feedback packet starting with a fourth identifier.

8. The SPI data writing method according to claim 7, wherein the SPI interface module comprises a timeout timer; and
when the SPI interface module does not receive the write status packet before timeout, if the SPI master controller generates a clock edge on the SPI_CK signal line after timeout and reads the write feedback packet via the SPI_MISO signal line, the SPI interface module sends the write failure feedback packet to the SPI master controller via the SPI_MISO signal line.

9. An SPI data reading method, using an SPI interface system for data reading, and comprising:
providing the SPI interface system, wherein the SPI interface system comprises an SPI interface module and at least one functional module, the SPI interface module is connected to an SPI master controller via an SPI_CK signal line, an SPI_MOSI signal line and an SPI_MISO signal line, and the functional module is connected to the SPI interface module;
the SPI master controller generating a clock edge on the SPI_CK signal line and sending a read command packet to the SPI interface module via the SPI_MOSI signal line, wherein the read command packet starts with a fifth identifier;
after the SPI interface module receives the read command packet from the SPI_MOSI signal line, sending the read command packet to the functional module;
the functional module receiving the read command packet and executing a read command, and when the functional module completes the read command, returning a read data packet to the SPI interface module;
the SPI master controller generating a clock edge on the SPI_CK signal line and reading a read feedback packet via the SPI_MISO signal line; and
upon receiving the read data packet, the SPI interface module sending the read feedback packet via the SPI_MISO signal line, wherein the read feedback packet starts with a sixth identifier and comprises the read data contained in the read data packet.

10. The SPI data reading method according to claim 9, wherein if the data received by the SPI interface module from the SPI_MOSI signal line reaches a length of the read command packet, the SPI interface module has received the read command packet.

11. The SPI data reading method according to claim 9, wherein the read command packet further comprises a read command packet checksum; and
if the data received by the SPI interface module from the SPI_MOSI signal line reaches the length of the read command packet and the read command packet checksum is verified as correct, the SPI interface module has received the read command packet.

12. The SPI data reading method according to claim 9, wherein the SPI master controller generates a clock edge on the SPI_CK signal line and reads the read feedback packet via the SPI_MISO signal line; and
if the SPI interface module does not receive the read data packet, the SPI interface module sends data that cannot be recognized as the read feedback packet to the SPI master controller via the SPI_MISO signal line.

13. The SPI data reading method according to claim 9, wherein the SPI interface module comprises a timeout timer; and
if the SPI interface module does not receive the read data packet before timeout, and after timeout, the SPI master controller generates a clock edge on the SPI_CK signal line to read the read feedback packet via the SPI_MISO signal line; and
then the SPI interface module sends the read feedback packet to the SPI master controller via the SPI_MISO signal line.

14. The SPI data reading method according to claim 9, wherein the SPI master controller generates a clock edge on the SPI_CK signal line and sends the read command packet to the SPI interface module via the SPI_MOSI signal line; and
then, the SPI master controller generates a clock edge on the SPI_CK signal line and reads the read feedback packet via the SPI_MISO signal line; and after sending the read feedback packet via the SPI_MISO signal line, the SPI interface module can continue to receive subsequent command packets, wherein the subsequent command packets comprise read command packets and write command packets.

15. The SPI data reading method according to claim 9, wherein the read feedback packet is divided into a read success feedback packet and a read failure feedback packet;
the SPI master controller generates a clock edge on the SPI_CK signal line and reads the read feedback packet via the SPI_MISO signal line;
if the SPI interface module receives the read data packet and the status information contained in the read data packet indicates success, the SPI interface module sends the read success feedback packet via the SPI_MISO signal line, wherein the read success feedback packet starts with a seventh identifier; and
if the SPI interface module receives the read data packet and the status information contained in the read data packet indicates failure, the SPI interface module sends the read failure feedback packet via the SPI_MISO signal line, wherein the read failure feedback packet starts with an eighth identifier.

16. The SPI data reading method according to claim 15, wherein the SPI interface module comprises a timeout timer; and
if the SPI interface module does not receive the read data packet before timeout, and after timeout the SPI master controller generates a clock edge on the SPI_CK signal line to read the read feedback packet via the SPI_MISO signal line, the SPI interface module sends the read failure feedback packet to the SPI master controller via the SPI_MISO signal line.
